(19) United States
(12) Patent Application Publication
(10) Pub. No.: US 2026/0292525 A1
(43) Pub. Date: Sep. 24, 2026

(54) RADIO ZONE DESIGN APPARATUS, RADIO ZONE DESIGN METHOD, AND PROGRAM

(71) Applicant: NTT, Inc., Tokyo (JP)

(72) Inventors: Daisuke MURAYAMA, Tokyo (JP); Toshiro NAKAHIRA, Tokyo (JP); Takatsune MORIYAMA, Tokyo (JP)

(21) Appl. No.: 19/490,125

(22) PCT Filed: Jun. 9, 2023
(86) PCT No.: PCT/JP2023/021615

§ 371 Date: Dec. 4, 2025

(51) Int. Cl. H04W 16/20

(52) U.S. Cl. CPC H04W 16/20

(57) ABSTRACT

A radio zone design apparatus includes a division unit configured to divide a plurality of evaluation points in a wireless area into a predetermined number of clusters based on a radio wave propagation loss between the evaluation points; an estimation unit configured to estimate, for each of the clusters, radio wave propagation to each of the evaluation points in the cluster from a candidate for an installation location of a wireless base station or a relay station represented by a combination of the installation location and orientation; and an output unit configured to output the installation location and orientation of the wireless base station or the relay station with a maximum quality evaluation index at the evaluation point in the cluster based on an estimation result of the estimation of the radio wave propagation.

### TECHNICAL FIELD

The present invention relates to a radio zone design apparatus, a radio zone design method, and a program.

### BACKGROUND ART

A radio zone design apparatus and a radio zone design method are known that design, for example, an appropriate installation location of a wireless base station for constructing a wireless area.

### CITATION LIST

### Non-Patent Literature

Non-Patent Literature 1: “Radio Zone Design in Mobile Communication”, NTT DoComo Technical Journal (Vol. 2, No. 4), [retrieved on May 30, 1992], the Internet <https://www.nttdocomo.co.jp/binary/pdf/corporate/technolog y/rd/technical_journal/bn/vol2_4/vol2_4_035jp.pdf>

### SUMMARY OF INVENTION

### Technical Problem

In the conventional radio zone design method, an installation location and orientation of a wireless base station or the like (a wireless base station or a relay station) are selected from simulation results for wireless communication quality at a plurality of evaluation points in a wireless area under a condition that, for example, the number of evaluation points satisfying predetermined wireless communication quality is the largest.

However, in this method, when the number of candidates for the installation location and orientation of the wireless base station or the like increases, there is a problem that the calculation time required for comparing and evaluating the calculation results for all combinations of the installation location and orientation of the wireless base station or the like becomes enormous.

An embodiment of the present invention has been made in view of the above problems and reduces a calculation time required for designing in a radio zone design apparatus configured to design an installation location and orientation of a wireless base station or the like.

### Solution to Problem

In order to solve the above problems, according to an embodiment of the present invention, there is provided a radio zone design apparatus configured to design an installation location and orientation of a wireless base station or a relay station, the radio zone design apparatus including: a division unit configured to divide a plurality of evaluation points in a wireless area into a predetermined number of clusters based on a radio wave propagation loss between the evaluation points; an estimation unit configured to estimate, for each of the clusters, radio wave propagation to each of the evaluation points in the cluster from a candidate for the installation location of the wireless base station or the relay station represented by a combination of the installation location and the orientation; and an output unit configured to output the installation location and orientation of the wireless base station or the relay station with a maximum quality evaluation index at the evaluation point in the cluster based on an estimation result of the estimation of the radio wave propagation.

### Advantageous Effects of Invention

According to the embodiment of the present invention, it is possible to reduce a calculation time required for designing in the radio zone design apparatus configured to design the installation location and orientation of the wireless base station or the like.

### BRIEF DESCRIPTION OF DRAWINGS

FIG. 1 is a diagram illustrating a configuration example of a radio zone design apparatus according to the present embodiment.

FIG. 2 is a flowchart (1) illustrating an example of radio zone design processing according to the present embodiment.

FIG. 3 is a diagram for describing a radio zone design processing according to the present embodiment.

FIG. 4 is a flowchart (2) illustrating an example of radio zone design processing according to the present embodiment.

FIG. 5 is a diagram illustrating an example of a hardware configuration of a radio zone design apparatus according to the present embodiment.

### DESCRIPTION OF EMBODIMENTS

An embodiment of the present invention (the present embodiment) will be described below with reference to the drawings. The embodiment to be described below is merely an example, and embodiments to which the present invention is applied are not limited to the following embodiment.

### <Configuration Example of Radio Zone Design Apparatus>

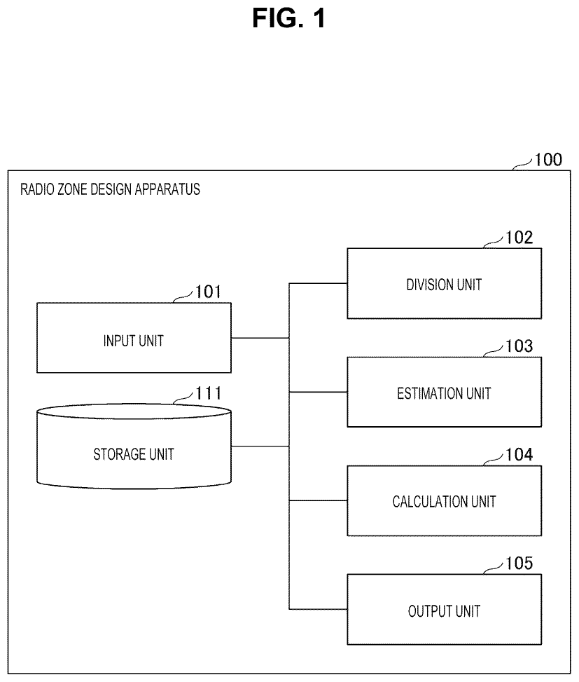

FIG. 1 is a diagram illustrating a configuration example of a radio zone design apparatus according to the present embodiment. A radio zone design apparatus 100 is an information processing device having a configuration of a computer or a system including a plurality of computers. The radio zone design apparatus 100 performs, for example, radio zone design for designing an installation location and orientation of an appropriate wireless base station or relay station (hereinafter, referred to as a “wireless base station or the like”) for constructing a wireless area.

In the radio zone design apparatus 100, for example, a computer included in the radio zone design apparatus 100 executes a program stored in a storage medium to implement functional components such as an input unit 101, a division unit 102, an estimation unit 103, a calculation unit 104, and an output unit 105. Furthermore, the radio zone design apparatus 100 includes, for example, a storage unit 111 implemented by a storage device or the like of the computer included in the radio zone design apparatus 100.

The input unit 101 receives various input operations for the radio zone design apparatus 100. For example, the input unit 101 receives an input of a design condition for radio zone design, and stores the received design condition in the storage unit 111 or the like.

The design condition for the radio zone design includes, for example, information such as radio zone location candidates, a plurality of evaluation points, required reception power (or required throughput), and the number of wireless base stations installed in the wireless area. Here, the radio zone location candidate is, for example, a candidate for an installation location of the wireless base station or the like, which is represented by a combination of the installation location and orientation of the wireless base station or the like. Note that the orientation of the wireless base station or the like includes, for example, an orientation of an antenna included in the wireless base station or the like, or an orientation in which the wireless base station or the like transmits and receives radio waves. A plurality of the evaluation points indicate points where reception power or the like is evaluated in the wireless area. The required reception power (or the required throughput) is a reference value (or a target value) or the like for determining whether or not sufficient reception power (or throughput) can be obtained at the evaluation point.

The division unit 102 executes division processing of dividing a plurality of the evaluation points in the wireless area into a predetermined number of clusters based on the radio wave propagation loss between the evaluation points. Preferably, the division unit 102 divides a plurality of the evaluation points into a predetermined number of clusters by a k-means++ method based on the radio wave spatial distance (radio wave propagation loss between the evaluation points). Preferably, the division unit 102 divides a plurality of the evaluation points in the wireless area into clusters corresponding in number to the wireless base station and the like installed in the wireless area. Note that a specific example of processing of dividing a plurality of the evaluation points into a predetermined number of clusters will be described later.

For example, the estimation unit 103 executes estimation processing of estimating radio wave propagation from the radio zone location candidate to the evaluation point in the cluster for each cluster divided by the division unit 102. For example, the estimation unit 103 calculates the reception power at each evaluation point in the cluster for each radio zone location candidate using a radio wave propagation characteristic simulation such as ray tracing or the like.

The calculation unit 104 calculates a quality evaluation index of each radio zone location candidate for each cluster based on the estimation result of the estimation of the radio wave propagation obtained by the estimation unit 103. An example of the quality evaluation index includes an average value of reception power at each evaluation point in the cluster or an average value of throughput predicted based on reception power at each evaluation point in the cluster.

Note that, in a case where the average value of the throughput is used, the calculation unit 104 may convert the reception power into the throughput using, for example, a conversion table between the reception power and the throughput, which is prepared in advance. Alternatively, the calculation unit 104 may predict the throughput by inputting the reception power to a prediction model trained by machine learning in advance so as to predict the throughput based on the reception power or the like.

The output unit 105 executes output processing of outputting the installation location and orientation of the wireless base station or the like (the wireless base station or the relay station) with the maximum quality evaluation index for each cluster based on the quality evaluation index calculated by the calculation unit 104. As another example, the output unit 105 may output the installation locations and orientations of a predetermined number of wireless base stations or the like in descending order of the quality evaluation indexes for each cluster based on the quality evaluation indexes calculated by the calculation unit 104.

The storage unit 111 stores, for example, various types of information including design conditions for the radio zone design received by the input unit 101 and estimation results of the estimation of the radio wave propagation calculated by the estimation unit 103, data, programs, and the like.

Note that the functional component of the radio zone design apparatus 100 illustrated in FIG. 1 is an example. For example, the storage unit 111 may be implemented by a storage server, a cloud service, or the like that is accessible by the radio zone design apparatus 100 via a communication network. Furthermore, each of the functional components described above is not limited to a physical machine (a computer), but may be implemented by, for example, a program executed by a virtual machine on a cloud. Moreover, at least some of the functional components described above may be implemented by hardware.

### <Flow of Processing>

Next, a flow of processing of a radio zone design method according to the present embodiment will be described.

### (Radio Zone Design Processing 1)

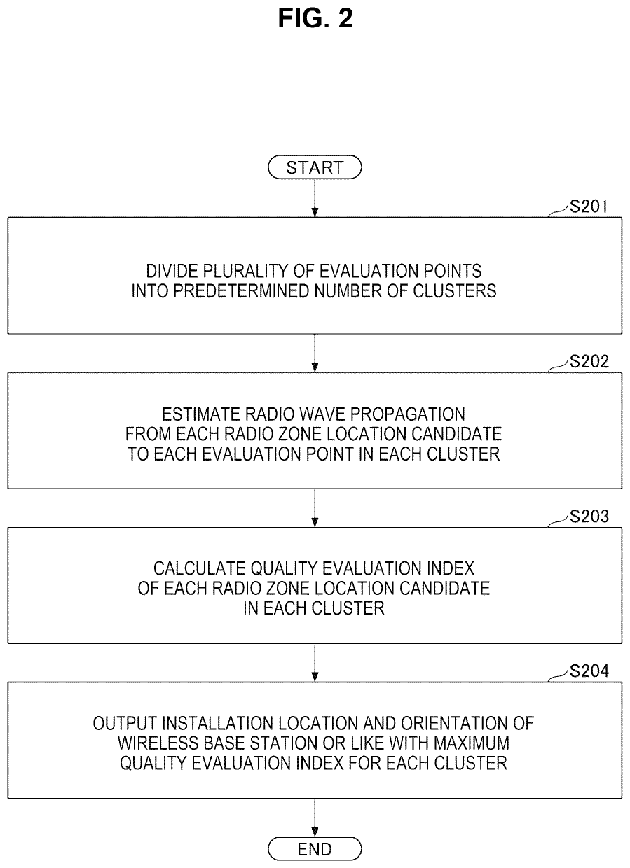

FIG. 2 is a flowchart illustrating an example of radio zone design processing according to the present embodiment. This processing indicates an example of the radio zone design processing executed by the radio zone design apparatus 100 described in FIG. 1.

In step S201, the division unit 102 divides a plurality of the evaluation points in the wireless area into a predetermined number of clusters. For example, the division unit 102 performs clustering by the k-means++ method based on the radio wave spatial distance (radio wave propagation loss between the evaluation points).

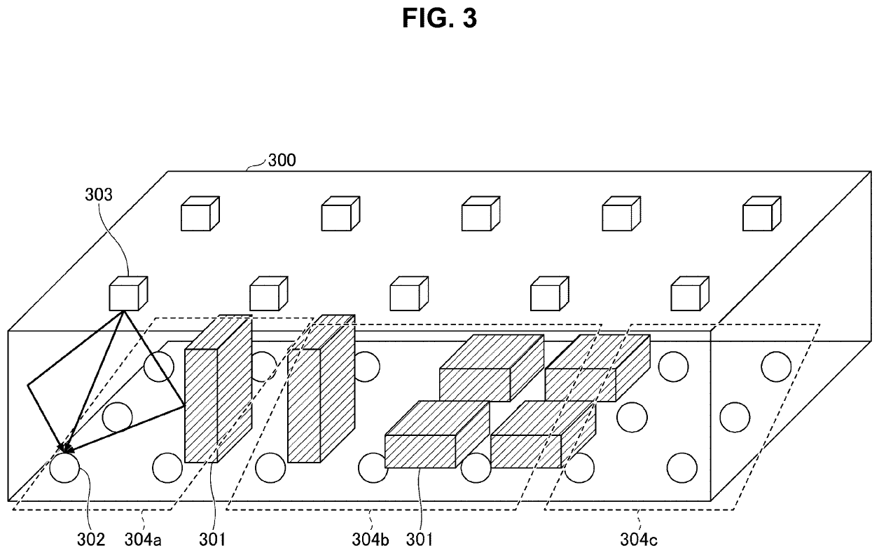

FIG. 3 is a diagram for describing the radio zone design processing according to the present embodiment. In an example of FIG. 3, a plurality of shielding objects 301, a plurality of evaluation points 302 which are points for evaluating the reception power from the wireless base station or the like, and a plurality of radio zone location candidates 303 are disposed in a wireless area 300. Furthermore, the example of FIG. 3 is an example in which a plurality of the evaluation points 302 are divided into three clusters 304a, 304b, and 304c.

As a preferable example, the division unit 102 divides a plurality of the evaluation points 302 in the wireless area 300 into clusters corresponding in number to of the wireless base station and the like (wireless base station or relay station) installed in the wireless area 300. Thus, for example, a predetermined number of wireless base stations and the like can be disposed in the wireless area 300 by determining the optimum arrangement location and orientation of the wireless base station and the like for each cluster.

In step S202, the estimation unit 103 estimates radio wave propagation from each radio zone location candidate 303 to each evaluation point 302 in each cluster. For example, as illustrated in FIG. 3, the estimation unit 103 calculates, in the cluster 304a, reception power from the radio zone location candidate 303 to the evaluation point 302 using a radio wave propagation simulation such as ray tracing or the like. Similarly, the estimation unit 103 calculates the reception power for all combinations of the radio zone location candidates 303 and the evaluation points 302 in the cluster 304a. Moreover, the estimation unit 103 calculates the reception power for all combinations of the radio zone location candidates 303 and the evaluation points 302 in each cluster, similarly in the other clusters 304b and 304c.

Note that the estimation unit 103 may store the estimation result of the estimation of the radio wave propagation calculated in step S202 in the storage unit 111 and reuse the estimation result when the processing of FIG. 2 is executed again.

In step S203, the calculation unit 104 calculates the quality evaluation index of each radio zone location candidate 303 in each cluster based on the estimation result of the estimation of the radio wave propagation. Here, the quality evaluation index includes, for example, an average value of reception power received by each evaluation point 302 in the cluster from each radio zone location candidate 303 or an average value of throughput predicted based on the reception power.

In a case where the throughput is predicted, for example, the calculation unit 104 may predict the throughput from the conversion table of reception powers and throughputs, which is prepared in advance, by acquiring measurement data, using a link level simulation, or the like. Alternatively, the calculation unit 104 may predict the throughput by inputting the reception power to a prediction model trained by machine learning in advance so as to predict the throughput from the input reception power. Furthermore, the quality evaluation index may be, for example, an achievement rate of target reception power (or target throughput), the minimum reception power (or the minimum throughput), or the like.

In step S204, the output unit 105 outputs the installation location and orientation of the wireless base station or the like (the wireless base station or the relay station) with the maximum quality evaluation index for each cluster based on the quality evaluation index of each radio zone location candidate 303.

Through the processing of FIG. 3, the radio zone design apparatus 100 can output the installation location and orientation of the wireless base station or the like with the maximum quality evaluation index in each cluster.

### (Radio Zone Design Processing 2)

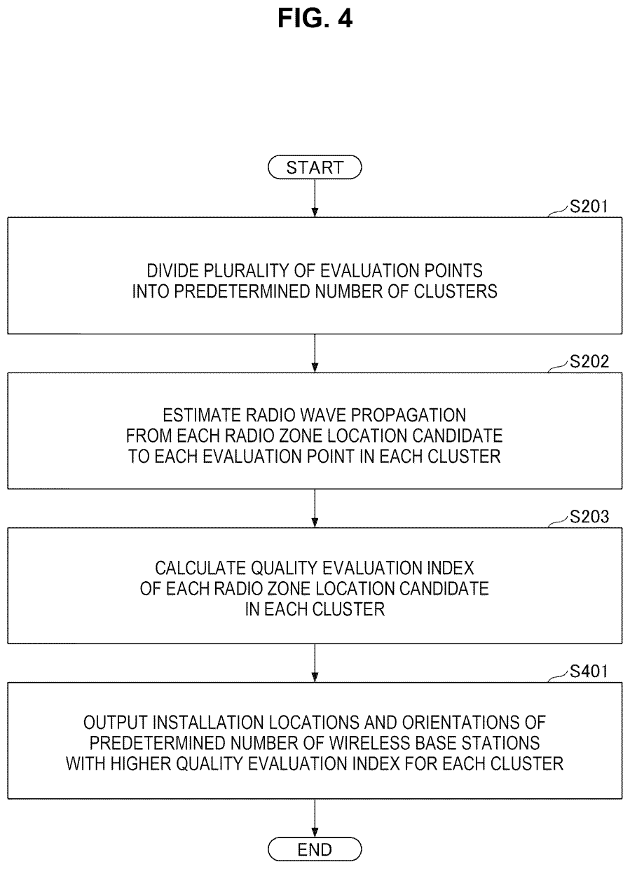

FIG. 4 is a flowchart illustrating an example of radio zone design processing according to the present embodiment. For example, this processing indicates another example of the radio zone design processing executed by the radio zone design apparatus 100 described in FIG. 1. Note that in the processing of FIG. 4, the processing in steps S201 to S203 is substantially the same as the processing in steps S201 to S203 described in FIG. 2, and thus description thereof will be omitted here.

In step S401, the output unit 105 outputs the installation locations and orientations of a predetermined number of wireless base stations with the higher quality evaluation index for each cluster based on the quality evaluation index of each radio zone location candidate 303. Preferably, the output unit 105 outputs the installation locations and orientations of a predetermined number of wireless base stations in descending order of the quality evaluation indexes.

Through the processing of FIG. 4, for example, in a case where the installation locations of the wireless base stations with the largest quality evaluation index are biased in each cluster, it is easy to determine the arrangement location and orientation of the wireless base station or the like such that the arrangement locations of the wireless base stations or the like are uniform.

### (Cluster Division Processing)

Here, an example of cluster division processing in which the division unit 102 divides a plurality of the evaluation points 302 in the wireless area 300 into a predetermined number of clusters will be described.

In a case where the number of wireless base stations is N (N is an integer of two or more), the division unit 102 divides a plurality of the evaluation points 302 into N clusters by the k-means++ method.

The k-means++ is one of clustering methods for dividing given data into a predetermined number of clusters.

In the k-means++, a distance D from a randomly selected evaluation point i, used as an initial value, to the nearest neighbor center of the point i is calculated, and an evaluation point i+1 to be the next cluster center is randomly selected using the weighted probability distribution (D\hat{ }2/ΣD\hat{ }2). The division unit 102 repeatedly executes this processing to select N cluster centers.

Furthermore, the division unit 102 generates a cluster by the following (Formula 1) using the selected N cluster centers as initial values.

$$\begin{matrix}[ Math . 1 ] & \\ {min}_{{C}_{j}} f = {\sum }_{j = 1}^{k} {\sum }_{{x}_{i} ∈ {C}_{j}} ‖ vi - {m}_{j} ‖ & ( Formula 1 )\end{matrix}$$

Here, Cj is a cluster, and ∥vi-mj∥ is a distance between a centroid (cluster centroid) and a cluster element.

In the present embodiment, in the k-means++ method described above, the radio wave propagation loss (radio wave spatial distance) between the evaluation points 302 is used as the distance D between the evaluation points. For example, as illustrated in FIG. 3, the radio wave propagation loss between the evaluation points 302 is calculated using the radio wave propagation simulation or the like in consideration of the influence of a plurality of the shielding objects 301. Alternatively, the radio wave propagation loss between the evaluation points 302 may be measurement data or the like. Furthermore, the radio wave propagation loss between the evaluation points 302 may be calculated by the estimation unit 103, or a value calculated or measured in advance may be stored in the storage unit 111 or the like.

Note that the radio wave propagation loss between the centroid and the cluster element in (Formula 1) may be calculated and acquired as needed, or the radio wave propagation loss between an evaluation point A and another evaluation point 302 may be used assuming that the centroid is the same as the evaluation point A of the nearest coordinates.

Here, the k-means++ method is an example, and the division unit 102 may divide a plurality of the evaluation points 302 into N clusters using the radio wave propagation loss between the evaluation points 302 and another clustering algorithm.

Thus, the radio zone design apparatus 100 according to the present embodiment can perform clustering calculation in consideration of the shielding objects 301. Therefore, the radio zone design apparatus 10 according to the present embodiment is particularly suitable, for example, for radio zone design in a system of a relatively high frequency band and in an environment having a large influence of the shielding objects.

### Hardware Configuration Example

### (Hardware Configuration of Radio Zone Design Apparatus)

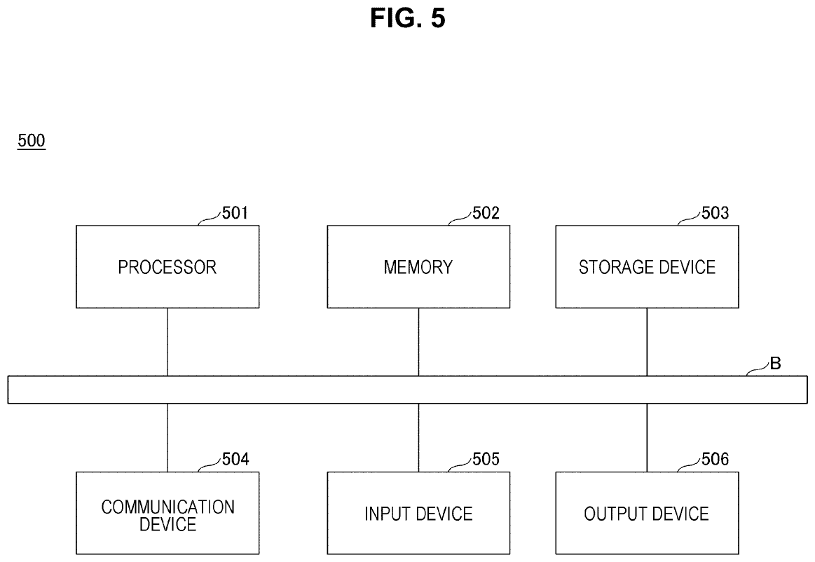

FIG. 5 is a diagram illustrating an example of a hardware configuration of the radio zone design apparatus according to the present embodiment. The radio zone design apparatus 100 has, for example, a hardware configuration of a computer 500 as illustrated in FIG. 5. In an example of FIG. 5, the computer 500 includes a processor 501, a memory 502, a storage device 503, a communication device 504, an input device 505, an output device 506, and a bus B.

The processor 501 is, for example, an arithmetic device such as a central processing unit (CPU) that implements various functions by executing a predetermined program. The memory 502 is a storage medium readable by the computer 500 and includes, for example, a random access memory (RAM) and a read only memory (ROM). The storage device 503 is a computer-readable storage medium, and can include, for example, a hard disk drive (HDD), a solid state drive (SSD), various optical discs, and a magneto-optical disk.

The communication device 504 includes one or more pieces of hardware (communication devices) for communicating with other devices via a wireless or wired network. The input device 505 is an input device (for example, a keyboard, a mouse, a microphone, a switch, a button, or a sensor) that receives an input from the outside. The output device 506 is an output device (for example, a display, a speaker, or an LED lamp) that performs output to the outside. Note that the input device 505 and the output device 506 may be integrated (for example, an input/output device such as a touch panel display or the like).

The bus B is commonly connected to the above-described components and transmits, for example, an address signal, a data signal, various control signals, and the like. Note that the processor 501 is not limited to a CPU, and may be, for example, a digital signal processor (DSP), a programmable logic device (PLD), or a field programmable gate array (FPGA).

### (Supplementary Note)

The radio zone design apparatus 100 in the present embodiment is not limited to implementation by a dedicated device, and may be implemented by a general-purpose computer. In that case, a program for implementing the functions may be recorded in a computer-readable recording medium, and the functions may be implemented by loading the program recorded in this recording medium to a computer system, and executing the program. Note that the “computer system” referred to herein includes an OS and hardware such as a peripheral device or the like.

Furthermore, the “computer-readable recording medium” includes various storage devices such as a portable medium such as a flexible disk, a magneto-optical disk, a ROM, and a CD-ROM, and a hard disk built in the computer system. Moreover, the “computer-readable recording medium” may include a medium that dynamically holds a program for a short time, such as a communication line in a case where the program is transmitted via a network such as the Internet or the like, or a communication line such as a telephone line or the like, and a medium that holds a program for a certain period of time, such as a volatile memory inside the computer system serving as a server or a client in that case.

Furthermore, the program may be provided for implementing part of the above-described functions, may be capable of implementing the above-described functions in combination with a program already recorded in the computer system or may be implemented by using hardware such as a programmable logic device (PLD), a field programmable gate array (FPGA), or the like.

### Effects of Embodiment

According to the present embodiment, it is possible to reduce a calculation time required for designing in the radio zone design apparatus 100 configured to design the installation location and orientation of the wireless base station or the like.

Furthermore, since the radio zone design apparatus 100 can perform clustering calculation in consideration of the shielding objects 301, it is particularly suitable for network designing in a system with a relatively high frequency band and in an environment having the large influence of the shielding objects 301.

<Summary of embodiment>

The present specification discloses at least a radio zone design apparatus, a radio zone design method, and a program below.

### (Clause 1)

A radio zone design apparatus configured to design an installation location and orientation of a wireless base station or a relay station, the radio zone design apparatus including:
a division unit configured to divide a plurality of evaluation points in a wireless area into a predetermined number of clusters based on a radio wave propagation loss between the evaluation points;
an estimation unit configured to estimate, for each of the clusters, radio wave propagation to each of the evaluation points in the cluster from a candidate for the installation location of the wireless base station or the relay station represented by a combination of the installation location and the orientation; and
an output unit configured to output the installation location and orientation of the wireless base station or the relay station with a maximum quality evaluation index at the evaluation point in the cluster based on an estimation result of the estimation of the radio wave propagation.

### (Clause 2)

The radio zone design apparatus according to Clause 1, in which the division unit divides the plurality of evaluation points in the wireless area into the predetermined number of clusters by a k-means++ method using the radio wave propagation loss between the evaluation points as a distance between the evaluation points.

### (Clause 3)

The radio zone design apparatus according to Clause 1 or 2,
in which the division unit divides the plurality of evaluation points in the wireless area into clusters corresponding in number to the wireless base station or relay station installed in the wireless area, and
the output unit outputs, for each of the clusters, the installation location and orientation of the wireless base station or the relay station with the maximum quality evaluation index at the evaluation point in the cluster.

### (Clause 4)

The radio zone design apparatus according to any one of Clauses 1 to 3, in which the quality evaluation index includes an average value of reception power at the evaluation points calculated by the estimation of the radio wave propagation or an average value of throughput predicted based on the reception power.

### (Clause 5)

The radio zone design apparatus according to any one of Clauses 1 to 4, in which the output unit outputs the installation locations and orientations of a predetermined number of wireless base stations or relay stations with higher quality evaluation indexes at the evaluation points in the cluster.

### (Clause 6)

A radio zone design method causing a radio zone design apparatus configured to design an installation location and orientation of a wireless base station or a relay station to execute:
processing of dividing a plurality of evaluation points in a wireless area into a predetermined number of clusters based on a radio wave propagation loss between the evaluation points;
processing of estimating, for each of the clusters, radio wave propagation to each of the evaluation points in the cluster from a candidate for the installation location of the wireless base station or the relay station represented by a combination of the installation location and the orientation; and
processing of outputting the installation location and orientation of the wireless base station or the relay station with a maximum quality evaluation index at the evaluation point in the cluster based on an estimation result of the estimation of the radio wave propagation.

### (Clause 7)

A storage medium storing a program that causes a computer for designing an installation location and orientation of a wireless base station or a relay station to execute:
processing of dividing a plurality of evaluation points in a wireless area into a predetermined number of clusters based on a radio wave propagation loss between the evaluation points;
processing of estimating, for each of the clusters, radio wave propagation to each of the evaluation points in the cluster from a candidate for the installation location of the wireless base station or the relay station represented by a combination of the installation location and the orientation; and
processing of outputting the installation location and orientation of the wireless base station or the relay station with a maximum quality evaluation index at the evaluation point in the cluster based on an estimation result of the estimation of the radio wave propagation.

Although the present embodiment has been described above, the present invention is not limited to such a specific embodiment, and various modifications and changes can be made within the scope of the present invention described in the claims.

### REFERENCE SIGNS LIST

100 Radio zone design apparatus
102 Division unit
103 Estimation unit
104 Calculation unit
105 Output unit
111 Storage unit
500 Computer

1. A radio zone design apparatus configured to design an installation location and orientation of a wireless base station or a relay station, the radio zone design apparatus comprising:
a memory; and
a processor coupled to the memory, the memory storing one or more programs, which when executed, cause the processor to:
divide a plurality of evaluation points in a wireless area into a predetermined number of clusters based on a radio wave propagation loss between the evaluation points;
estimate, for each of the clusters, radio wave propagation to each of the evaluation points in the cluster from a candidate for the installation location of the wireless base station or the relay station represented by a combination of the installation location and the orientation; and
output the installation location and orientation of the wireless base station or the relay station with a maximum quality evaluation index at the evaluation point in the cluster based on an estimation result of the estimation of the radio wave propagation.

2. The radio zone design apparatus according to claim 1, wherein
the processor divides the plurality of evaluation points in the wireless area into the predetermined number of clusters by a k-means++ method using the radio wave propagation loss between the evaluation points as a distance between the evaluation points.

3. The radio zone design apparatus according to claim 1, wherein
the processor divides the plurality of evaluation points in the wireless area into clusters corresponding in number to the wireless base station or relay station installed in the wireless area, and outputs, for each of the clusters, the installation location and orientation of the wireless base station or the relay station with the maximum quality evaluation index at the evaluation point in the cluster.

4. The radio zone design apparatus according to claim 1, wherein
the quality evaluation index includes an average value of reception power at the evaluation points calculated by the estimation of the radio wave propagation or an average value of throughput predicted based on the reception power.

5. The radio zone design apparatus according to claim 1, wherein
the processor outputs the installation locations and orientations of a predetermined number of wireless base stations or relay stations with higher quality evaluation indexes at the evaluation points in the cluster.

6. A radio zone design method executed by a radio zone design apparatus configured to design an installation location and orientation of a wireless base station or a relay station, the radio zone design method comprising:
dividing a plurality of evaluation points in a wireless area into a predetermined number of clusters based on a radio wave propagation loss between the evaluation points;
estimating, for each of the clusters, radio wave propagation to each of the evaluation points in the cluster from a candidate for the installation location of the wireless base station or the relay station represented by a combination of the installation location and the orientation; and
outputting the installation location and orientation of the wireless base station or the relay station with a maximum quality evaluation index at the evaluation point in the cluster based on an estimation result of the estimation of the radio wave propagation.

7. A non-transitory computer-readable recording medium storing a program, which when executed, causes a computer configured to design an installation location and orientation of a wireless base station or a relay station to execute:
processing of dividing a plurality of evaluation points in a wireless area into a predetermined number of clusters based on a radio wave propagation loss between the evaluation points;
estimating, for each of the clusters, radio wave propagation to each of the evaluation points in the cluster from a candidate for the installation location of the wireless base station or the relay station represented by a combination of the installation location and the orientation; and
outputting the installation location and orientation of the wireless base station or the relay station with a maximum quality evaluation index at the evaluation point in the cluster based on an estimation result of the estimation of the radio wave propagation.
